(19) United States
(12) Patent Application Publication
(10) Pub. No.: US 2017/0248923 A1
(43) Pub. Date: Aug. 31, 2017

(54) WATCH OR THE LIKE

(71) Applicant: ZERO S.A., Chiasso (CH)

(72) Inventor: Tarcisio Tasso, Chiasso (CH)

(21) Appl. No.: 15/500,144

(22) PCT Filed: Jul. 30, 2015
(86) PCT No.: PCT/IB2015/055751

§ 371 Date: Jan. 30, 2017

(30) Foreign Application Priority Data
Jul. 30, 2014 (IT) MO2014A000226

(51) Int. Cl. G04B 37/05; G04B 37/00

(52) U.S. Cl. CPC G04B 37/052; G04B 37/0008

(57) ABSTRACT

A watch or the like having a support member comprising an internal housing seat having a rear opening. A horology mechanism is housed inside the housing seat and has a rear portion arranged facing towards the rear opening. A bottom element is associated in a removable manner with the support member for closing the rear opening. The bottom element has a portion made of a yielding material, facing inside the housing seat and associated with at least part of the rear portion of the mechanism.

### TECHNICAL FIELD

The present invention relates to a wrist watch or the like.

### BACKGROUND ART

Generally, a watch is formed by a bearing case within which are contained a working mechanism and a dial with hands to indicate the hours and minutes.

The case generally consists of three parts: an upper transparent part called “crystal”, a central body called “case middle” and a lower part called “back”.

The back is the lower part of the case and constitutes the bottom of the structure that contains and protects the watch mechanism.

More specifically, the back surface facing towards the inside of the case middle serves as the base for the watch mechanism, while the outer surface constitutes the portion of the case which is normally placed in contact with the user's wrist.

Known backs are substantially plate-shaped elements which can be fixed to the case using different techniques such as, e.g., screwing in a special threaded seat, the application of fixing screws, or pressure fitting.

In any case, the passage of water or other liquids must be prevented through the contact surfaces between the back and the case walls.

In this respect, the method most frequently employed involves the use of a special rubber sealing ring, known as “o-ring”, suitably positioned in correspondence to a substantially circular seat engraved directly on the surface of the back.

Once the back has been positioned to close the case middle, the pressure applied by the contact surface of the case middle itself causes a deformation of the seal, thereby ensuring a correct seal.

In particular, the sealing ring so deformed applies a calculated mechanical stress on the contact walls, preventing the fluids with a pressure lower than the stress itself from entering the case.

The known backs have a number of drawbacks.

A first drawback is the fact that, because the back is made of predominantly rigid materials (above all metals), and because the watch mechanism is partly resting on it, shocks and vibrations are directly transmitted to the mechanism, thereby increasing the risk of damage or malfunction.

Another drawback concerns the sealing ring's seal.

The o-ring sealing ring, in fact, wears with the passage of time and the stress applied on the walls decreases, allowing the infiltration of liquids.

This makes necessary a periodical replacement of the sealing ring, with consequent and expensive assembly and disassembly operations of the various components.

### DESCRIPTION OF THE INVENTION

The main aim of the present invention is to provide a wrist watch or the like which allows maintaining over time a high impermeability to liquids.

Another object of the present invention is to provide a watch which ensures the mechanism is protected against knocks.

Another object of the present invention is to provide a watch whose back is simple to produce, with the consequent cutting of the time needed to make the single piece.

Another object of the present invention is to provide a watch which allows to overcome the mentioned drawbacks of the prior art within the ambit of a simple, rational, easy, effective to use and affordable solution.

The objects stated above are achieved by the present wrist watch or the like according to claim 1.

### BRIEF DESCRIPTION OF THE DRAWINGS

Other characteristics and advantages of the present invention will become better evident from the description of a preferred but not exclusive embodiment of a wrist watch or the like, illustrated by way of an indicative, but non-limiting example in the accompanying drawings, in which:

FIG. 1 is a view of the watch according to the invention;

FIG. 2 is an exploded view of the watch according to the invention;

FIG. 3 is an axonometric view from above of a detail of the watch according to the invention;

FIG. 4 is an axonometric view from below of a detail of the watch according to the invention.

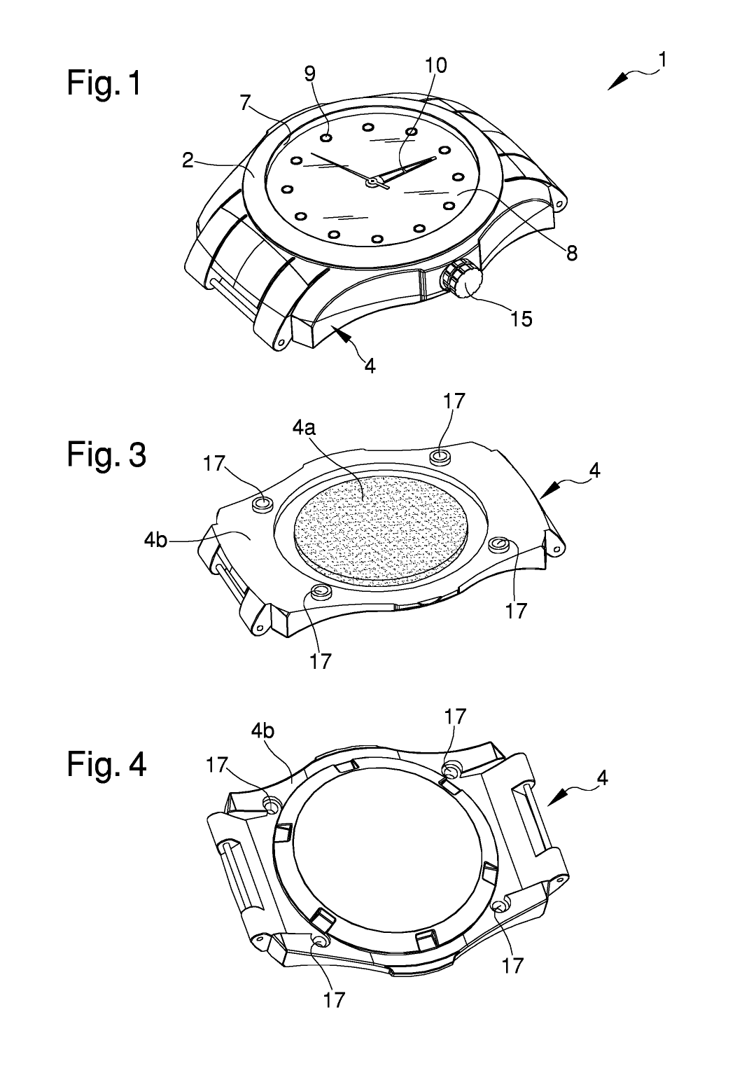

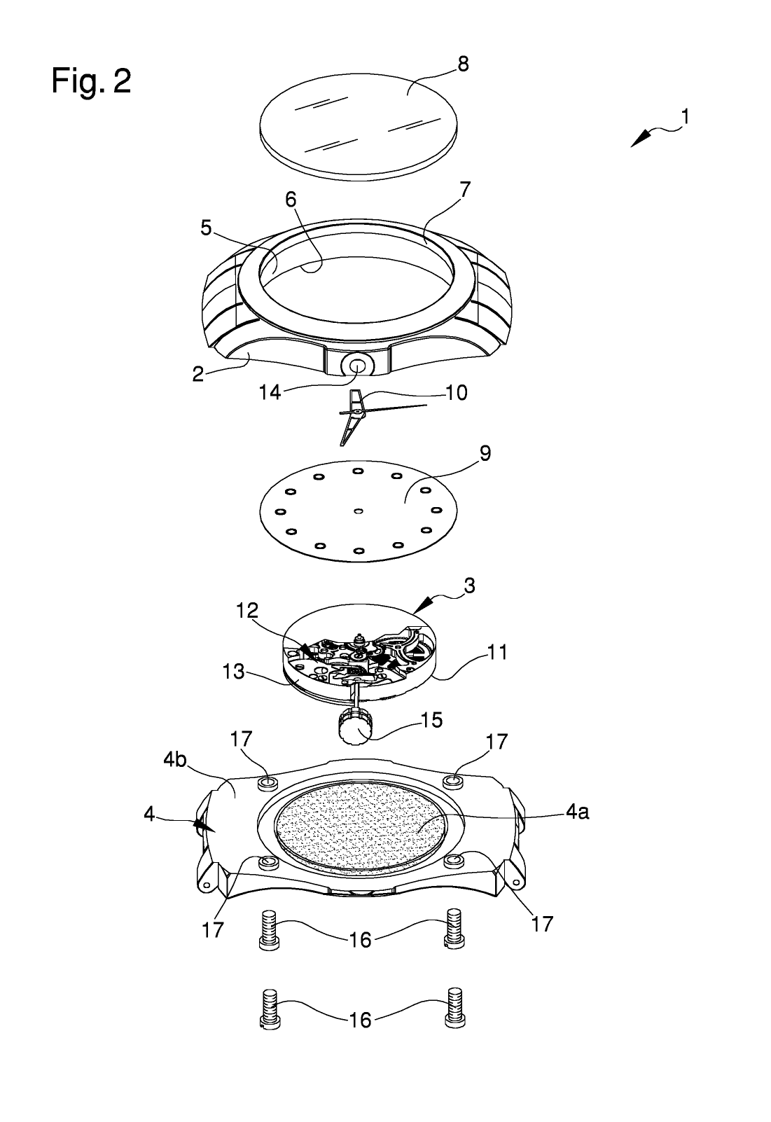

### EMBODIMENTS OF THE INVENTION

With particular reference to such illustrations, globally indicated with reference number 1 is a watch of the type of a wrist watch or the like. Different embodiments cannot however be ruled out.

The watch 1 comprises at least a support member 2, at least a horology mechanism 3 and at least a bottom element 4.

The support member 2 comprises at least an internal housing seat 5 having at least a rear opening 6.

The support member 2 is the middle part of the watch case, i.e., the median part of the substantially rigid casing defining the seat 5 in which to house the various parts that make up the watch itself.

In the present embodiment, the support member 2 is configured as a substantially ring-shaped element.

Alternative embodiments cannot be ruled out, wherein the support member 2 has a different shape.

The support member 2 has a front opening 7 and a rear opening 6.

In particular, the front opening 7 is the opening through which it is possible to see the time and, with reference to the watch position during its normal use by a user, is the visible upper opening of the support member 2 itself.

In correspondence to this front opening 7 is usually affixed a transparent element 8 or “crystal” able to close the support member 2 of the watch at the top.

Internally, the support member 2 defines a housing seat 5 for the various parts that make up the watch.

In fact, within such seat 5 are placed the dial 9, the hands 10 and the mechanism 3.

The dial 9 is a substantially flat element, placed between the mechanism 3 and the crystal 8, and on the visible surface of which, i.e., the one facing the crystal 8, the symbols are shown which indicate the time (hours, minutes, other functions, etc.).

The hands 10 are placed on top of the dial 9 and are mechanically connected, usually by at least a shaft, to the mechanism 3.

The horology mechanism 3 is housed inside the housing seat 5, in particular it is placed underneath the dial 9.

The mechanism 3 has a rear portion 11 arranged facing towards the rear opening 6.

More in particular, the mechanism 3 is composed of a set 12 of gear wheels, pinions, balance wheels, pendulums and other elements useful to the movement of the hands, and is usually contained in a containment casing 13.

In the present embodiment, the dial 9, the hands 10 and the transparent element 8 are made of polymeric material.

In particular, the dial 9, the hands 10 and the transparent element 8 are made of substantially rigid polymeric material.

The rear opening 6 of the support member 2 is, with reference to the normal use of the watch 1 by a user, the opening arranged below the support member 2 itself, in contact with the user's wrist.

The bottom element 4 is associated in a removable manner with the support member 2 for closing the rear opening 6.

The bottom element 4 is a substantially plate-shaped element able to close the rear opening 6 so as to represent a bottom for the case of watch 1.

According of the invention, the bottom element 4 comprises at least a portion made of a yielding material 4a, facing inside the housing seat 5 and is placed in contact with at least one part of the rear portion 11 of the mechanism 3.

Preferably, the portion made of a yielding material 4a is made of elastically deformable polymeric material. The mechanism 3, therefore, is in contact with the elastically deformable material capable of damping impacts and vibrations that could damage the mechanism itself.

In so doing, the protection of the mechanism 3 increases during accidental falls or knocks, etc.

The bottom element 4 also comprises a portion 4b made of a substantially rigid material associated in a removable manner with the support member 2.

Preferably, the substantially rigid material is composed of a polymeric material.

Advantageously the support member 2 is also made of a rigid polymeric material.

To the side of the support member 2 a passage 14 is made able to permit the connection between the crown 15 and the mechanism 3.

The watch 1 comprises fixing means 16, 17 of the bottom element 4 to the support member 2.

For example, the fixing means 16, 17 may be composed of a plurality of holes 17 made in correspondence to at least a length of the portion 4b made of a substantially rigid material and at least a locking element 16 inserted inside the hole 17 and associated in a removable manner with the support member 2.

In the present embodiment there are four holes 17 made in correspondence to the portion 4b in rigid plastic.

In these holes 17 are accommodated the locking elements 16, in this case screws, so as to constrain the bottom element 4 to the support member 2.

The support member 2 is also made at least in part of a substantially rigid polymeric material.

Embodiments cannot be ruled out which provide for alternative solutions for the fixing of the bottom element 4 to the support member 2, such as, e.g., the screwing of the element itself to the rear opening 6, pressure slot-in or other solutions.

The bottom element 4 is substantially plate-shaped.

Advantageously, this is obtained by means of co-molding of the substantially rigid polymeric material with the elastically deformable polymeric material.

By so doing, a single piece is obtained comprising at least two different types of materials with different mechanical characteristics.

In particular, the bottom element 4 is composed, e.g., of a portion 4b of rigid polymer on which is fixed a portion 4a of elastically deformable polymer.

The portion 4a made of a yielding material is engaged along the entire edge of the rear opening 6.

In particular, this portion deforms under the constraining effect of the rear opening 6, carrying out the function of seal.

This, in fact, creates a response action, a mechanical stress along the entire edge of the rear opening, which in fact prevents the infiltration of liquids up to a predefined pressure.

In the present embodiment, the portion 4a made of a yielding material is substantially protruding.

In other words, the portion 4a protrudes overhanging from the rigid portion 4b.

In particular, the protruding portion 4a is fitted to measure in the rear opening 6.

The portion 4a made of a yielding material is also substantially disc-shaped.

In particular, the diameter of the portion 4a is greater than the diameter of the rear opening 6.

Embodiments cannot be ruled out wherein the bottom element 4, with relative portions 4a, 4b is shaped in a different manner, with forms and sizes compatible with the remaining component elements making up the case of watch 1.

The operation of the present invention is the following.

The bottom element 4 is associated with the support member 2 in such a way that the portion 4a is deformed and thus exerts a mechanical stress on the internal wall of the member itself, preventing the infiltration of liquids.

The mechanism 3 is placed in contact with the portion 4a of the bottom element 4, so as to exploit the damping effect of the deformable plastic.

It has in practice been ascertained how the described invention achieves the intended objects.

In particular the fact is underlined that the present invention ensures impermeability to liquids that lasts over time and protects the mechanism from shocks.

Furthermore, the use of plastic materials allows using the co-molding method, making single body pieces, easily replaceable, in a short time.

1. A watch comprising:
at least a support member comprising at least an internal housing seat having at least a rear opening;
at least a horology mechanism housed inside said housing seat and having a rear portion arranged facing towards said rear opening;
at least a bottom element associated in a removable manner with said support member for closing said rear opening; and
wherein said bottom element comprises at least a portion made of a yielding material, facing inside said housing seat and associated with at least part of said rear portion of the mechanism.

2. The watch according to claim 1, wherein said bottom element comprises at least a portion made of a substantially rigid material associated in a removable manner with said support member.

3. The watch according to claim 2, wherein said substantially rigid material comprises at least a substantially rigid polymeric material.

4. The watch according to claim 1, further comprising fixing means of said bottom element to said support member.

5. The watch according to claim 2, wherein said fixing means comprise at least a hole made in correspondence to at least a length of said portion made of a substantially rigid material and at least a locking element inserted inside said hole and associated in a removable manner with said support member.

6. The watch according to claim 1, wherein said support member is made at least in part of a substantially rigid polymeric material.

7. The watch according to claim 1, wherein said yielding material comprises at least an elastically deformable polymeric material.

8. The watch according claim 1, wherein said bottom element is substantially plate-shaped.

9. The watch according to claim 1, wherein said support member is made at least in part of a substantially rigid polymeric material, said yielding material comprises at least an elastically deformable polymeric material, and said bottom element is made by means of co-molding of said substantially rigid polymeric material with said elastically deformable polymeric material.

10. The watch according to claim 1, wherein said portion made of a yielding material is engaged along the entire edge of said rear opening.

11. The watch according to claim 1, wherein said portion made of a yielding material protrudes at least partially over a substantially rigid material of said bottom element.

12. The watch according to claim 11, wherein said portion made of a yielding material is fitted to measure in said rear opening.

13. The watch according to claim 1, wherein said portion made of a yielding material is substantially disc-shaped.
